(19) United States
(12) Patent Application Publication
(10) Pub. No.: US 2009/0273604 A1
(43) Pub. Date: Nov. 5, 2009

(54) Processing Vector Graphics

(76) Inventor: Young Ouk Kim, Gyeonggi-Do (KR)

Correspondence Address: FISH & RICHARDSON, PC, P.O. BOX 1022, MINNEAPOLIS, MN, 55440-1022, US

(21) Appl. No.: 12/426,176

(22) Filed: Apr. 17, 2009

(30) Foreign Application Priority Data
Apr. 17, 2008 (KR) 10-2008-0035626
Apr. 17, 2008 (KR) 10-2008-0035627

(51) Int. Cl. G06T 1/20

(52) U.S. Cl. 345/522; 345/501; 715/760; 715/234; 715/733; 719/328

(57) ABSTRACT

Techniques, apparatus, and system are described for providing a vector graphics processor. In one aspect, a vector graphics processor includes a preprocessing unit configured to generate a vector graphics element for vector graphics processing in response to receiving element data parsed from content included in an application. The vector graphics processor includes a converter to communicate with the preprocessing unit and configured to convert the generated vector graphics element into a vector graphics object. Also, the vector graphics processor includes a rendering unit to communicate with the converter and configured to render the vector graphics object by driving a vector graphics application programming interface (API).

### CLAIM OF PRIORITY

This application claims the benefit of priority of Korean Patent Application No. 10-2008-0035626 filed on Apr. 17, 2008 in the Korean Intellectual Property Office, and Korean Patent Application No. 10-2008-0035627 filed on Apr. 17, 2008 in the Korean Intellectual Property Office, the contents of which are incorporated by reference in their entirety herein.

### BACKGROUND

The present disclosure relates to vector graphics and, more particularly, to an apparatus and method for processing vector graphics in a mobile environment.

Vector graphics describes an image with mathematical statements instead of pixel information, which enables easy scalability without loss in image quality and usually results in a much smaller file size compared with raster graphics. Easy scalability with high resolution makes it ideal for navigation systems, and smaller file size means lower bandwidth for transmission and less memory for storage, which is appealing to mobile applications but generating burden on today's handheld devices. Therefore, the demand for vector graphics hardware accelerator is increasing.

Scalable vector graphics (SVG) as vector graphics are Web graphic standards stipulated by W3C that processes figures (i.e., points, lines, curves, and shapes or polygons) of images such as an extensible markup language (XML) application. As for the SVG, however, because many functions for driving are processed by software, a computation speed is slow in a mobile environment in which transport channels or hardware resources are limited, resulting in a low utilization of the SVG.

Evolving from hypertext markup language (HTML) Web pages processed in the first-generation and second-generation, mobile browsers are being transformed into full browsing forms orientating a third-generation enabling diverse vector graphics processing and dynamic HTML processing. The browsing methods of the first and second generations were limited in their use for processing data because respective content providers provide different contents. The browser-orientated third generation is expected to process vector graphics contained in Web documents and the like. However, for mobile devices, vector graphics-related content that requires much computation such as vector games and the like cannot fully be supported yet.

Possibility and immediacy of searching for various information are considered important characteristics of the Internet, but there is still a limitation for the current graphics processing schemes of mobile devices to process vector graphics.

### SUMMARY

In one aspect, a vector graphics processor includes a preprocessing unit configured to generate a vector graphics element for vector graphics processing in response to receiving element data parsed from content included in an application. The vector graphics processor includes a converter to communicate with the preprocessing unit and configured to convert the generated vector graphics element into a vector graphics object. Also, the vector graphics processor includes a rendering unit to communicate with the converter and configured to render the vector graphics object by driving a vector graphics application programming interface (API).

Implementations can optionally include one or more of the following features. The preprocessing unit can be configured to check whether the received element data is suitable for the vector graphics API, and when the element data is detected to be suitable for the vector graphics API, the preprocessing unit can generate the vector graphics element based on the vector graphics API. The preprocessing unit can include a database unit having attribute information defining each generated vector graphic element, and the preprocessing unit can be configured to check whether the received element data is suitable for the vector graphics API by comparing the received element data with the attribute information. The vector graphics processor can include a script parser configured to parse the received element data from the content. The script parser can support at least one of hypertext markup language (HTML), extensible markup language (XML), and cascading style sheet (CSS). The vector graphics API can be based on OpenVG.

In another aspect, a mobile device includes a processor configured to drive an application. The mobile device includes a vector graphics processor to communicate with the processor and configured to process content included in the application. The mobile device includes a display unit to communicate with the processor and the vector graphics processor, wherein the display unit is configured to display the application. The vector graphics processor includes a preprocessing unit configured to generate a vector graphics element for vector graphics processing in response to receiving element data parsed from the content. The vector graphics processor includes a converter to communicate with the preprocessing unit and configured to convert the generated vector graphics element into a vector graphics object. The vector graphics processor includes a rendering unit to communicate with the converter and configured to render the vector graphics object by driving a vector graphics application programming interface (API).

Implementations can optionally include one or more of the following features. The processor can include a script parser configured to parse the received element data from the content. The script parser can support at least one of hypertext markup language (HTML), extensible markup language (XML), and cascading style sheet (CSS). The preprocessing unit can be configured to check whether the received element data is suitable for the vector graphics API, and when the element data is suitable for the vector graphics API, the preprocessing unit can generate the vector graphics element based on the vector graphics API. The preprocessing unit can include a database unit having attribute information defining each generated vector graphic element, and the preprocessing unit can be configured to check whether the received element data is suitable for the vector graphics API by comparing the received element data with the attribute information. The application can be driven in a browser that displays information on the Web. The vector graphics API can be based on OpenVG.

In another aspect, a method of driving an application that includes content by a mobile device includes driving a vector graphics engine. The method includes parsing element data from the content. The method includes generating a vector graphics element for vector graphics processing from the parsed element data. The method includes converting the generated vector graphics element into a vector graphics object. The method includes rendering the vector graphics object by driving a vector graphics application programming interface (API), and displaying the rendered vector graphics object in the application.

Implementations can optionally include one or more of the following features. The method can include checking whether the parsed element data is suitable for the vector graphics API, and when detecting that the parsed element data is suitable for the vector graphics API, generating the vector graphics element based on the vector graphics API. Checking whether the received element data is suitable for the vector graphics API can include comparing the element data with attribute information. The method can include driving the application in a browser that displays information on the Web.

Implementations of the technique, apparatus and systems can potentially provide one or more of the following advantages. First, because the mobile browser supports vector graphics, rich, and diverse graphics content can be expressed. Second, vector graphics content can be implemented at a high processing rate only with small hardware resource of a mobile device whose mobility needs to be guaranteed. Third, because data such as various Web pages inputted via the browser can be effectively processed and managed, complexity of an operation of adding content fabricated through separate vector operations to mobile can be reduced. Fourth, various effects can be obtained by allowing vector graphics content to interact with other pure objects (HTML, Java script, etc.) and the like.

### BRIEF DESCRIPTION OF THE DRAWINGS

FIG. 1 is a schematic block diagram showing the configuration of a mobile device for implementing embodiments of the present disclosure.

FIG. 2 shows a hardware and software layer structure of the mobile device.

FIG. 3 is a schematic block diagram of the vector graphics processor according to an embodiment of the present disclosure.

FIG. 4 illustrates content driving using the vector graphics processor.

FIG. 5 is a flow chart illustrating a vector graphics processing method according to an embodiment of the present disclosure.

FIG. 6 is a flow chart illustrating an application driving method according to an embodiment of the present disclosure.

### DETAILED DESCRIPTION

OpenVG is a cross-platform application programming interface (API) that provides a low-level hardware acceleration interface for vector graphics libraries such as Flash® (from Adobe®, Inc.) and SVG. OpenVG is targeted primarily at handheld devices that need portable acceleration of high-quality vector graphics for compelling user interfaces and text on small screen devices—while enabling hardware acceleration to provide fluidly interactive performance at very low power levels.

Currently, there are two versions of OpenVG. OpenVG 1.0 is an API for hardware accelerated two-dimensional vector and raster graphics. It provides a device independent and vendor-neutral interface for sophisticated 2D graphical applications, while allowing device manufacturers to provide hardware acceleration on devices ranging from wrist watches to full microprocessor-based desktop and server machines. OpenVG 1.1, released on Dec. 8, 2008, adds a Glyph API for hardware accelerated text rendering, full acceleration support for Adobe® Flash® technologies, and multi-sampled anti-aliasing to the original OpenVG 1.0 specification. The OpenVG 1.1 specification is accompanied by an open source reference implementation and a full suite of conformance tests implemented by the Khronos Group.

The content of “OpenVG 1.1 Specification” which can be obtained from “http://www.khronos.org/registry/vg/” are hereby incorporated by reference.

For illustrative purposes, OpenVG is described in the present specification as a vector graphics API. The techniques, apparatus and systems described in this specification are applicable to any other vector graphics APIs.

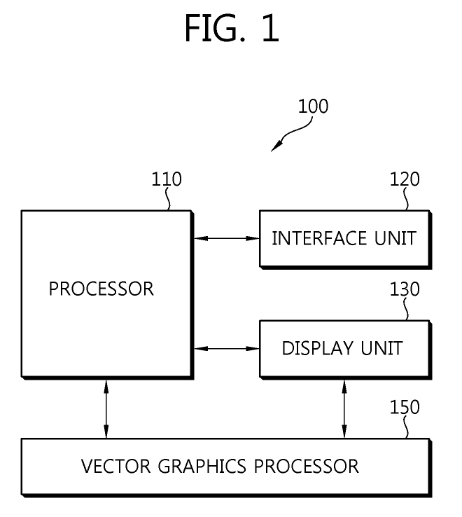

FIG. 1 is a schematic block diagram showing the configuration of a mobile device for implementing embodiments of the present disclosure. The mobile device 100 includes a processor 110, an interface unit 120, a display unit 130, and a vector graphics processor 150. The processor 110 processes an API inputted to the mobile device 100 and executes an application. The processor 110 may drive a browser to display information on a Web page. The application driven in the browser may include content supporting the OpenVG-based vector graphics. Upon receiving a request for performing vector graphics content from the browser, the vector graphics processor 150 processes vector graphics. The vector graphics processor 150 may support OpenVG-based vector graphics. The display unit 130 displays various information processed by the processor 110 or by the vector graphics processor 150 or by both. The interface unit 120 processes an interface with a user.

Here, the processor 110 and the vector graphics processor 150 are configured as shown as separate functional blocks for illustrative purposes only. The function of the vector graphics processor 150 may be embedded in the processor 110. The processor 110 may be divided into several functional blocks according to diverse functions to be described herein.

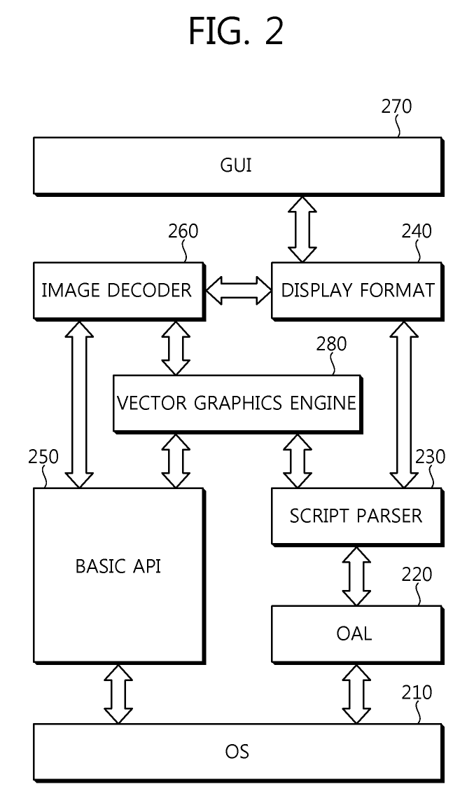

FIG. 2 shows a hardware and software layer structure of a mobile device. A vector graphics engine 280 may be implemented by the vector graphics processor 150. Other elements of the hardware and software layer structure may be implemented by the processor 110 or other function blocks or the processor 110 and other functional blocks.

An operating system (OS) 210 constitutes a basic platform of the mobile device. An OS adaptation layer (OSL) 220 interfaces hardware and the OS 210. A script parser 230 parses various protocols, e.g., HTML, Java script, and the like, which are needed for the browser. A basic API 250 processes basic APIs for driving the browser. A vector graphics engine 280 processes a vector graphics API. Data (e.g., rendering data) processed by the basic API 250 or by the vector graphics engine 280 or by both are decoded by an image decoder 260. A display format 240 generates an image to be outputted to a graphics user interface (GUI) 270 based on information inputted from the image decoder 260 or from the script parser 230 or from both, and performs a display format conversion.

In this layer structure, various contents included in the Web page are processed using the basic API 250 or using the vector graphics engine 280 or using both, and vector elements included in a vector graphics application are processed via the vector graphics engine 280.

By allowing the browser of the mobile device to support the vector graphics, rich and diverse graphics content can be expressed in a mobile environment. In addition, with the vector graphics engine embedded in the mobile device, vector graphics content can be implemented at a high processing speed using a small hardware resource of the mobile device.

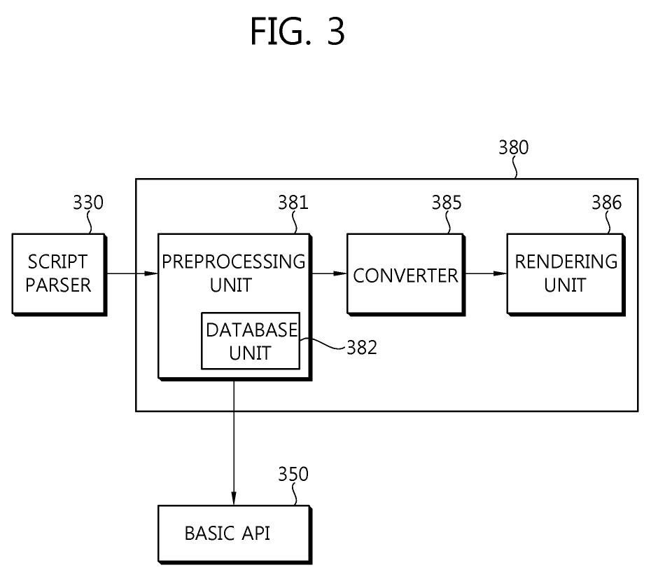

FIG. 3 is a schematic block diagram of a vector graphics processor according to an embodiment of the present disclosure. The vector graphics processor 380 includes a preprocessing unit 381, a converter 385, and a rendering unit 386.

A script parser 330 parses element data from the content included in an application. The application may be driven in a browser. The element data may include various tags used for processing graphics of content. The script parser 330 may support at least one of hypertext markup language (HTML), extensible markup language (XML), and cascading style sheet (CSS). Further, the script parser 330 may also support a Java script. In order to parse the HTML, the XML, the CSS, and the like, of the browser, the script parser 330 may include an HTML parser, an XML parser, a CSS parser, and the like. The script parser 330 may be a part of the processor 110. Alternatively, the script parser 330 may be included in elements of the vector graphics processor 380.

The preprocessing unit 381 receives the element data parsed from the content and generates a vector graphics element for processing vector graphics. Because the element data is at least partly made up of an HTML Tag and the like that processes a vector element suitable for the OpenVG, an object is generated.

The preprocessing unit 381 converts the element data into a vector graphics object corresponding to the OpenVG syntax. OpenVG API-based vector graphics include path, ellipse, line, arc, image, font, scale, transformation, rotate, shear, gradient, scissor, and the like. The preprocessing unit 381 checks whether or not the element data is suitable for the OpenVG API, and if the element data is suitable for the OpenVG API, the preprocessing unit 381 may generate a vector graphics element. The preprocessing unit 381 may include a database unit 382 having attribute information defining each vector graphics element. The preprocessing unit 381 may check whether or not the element data is suitable for the OpenVG API by comparing the element data and the attribute information in the database unit 382. If the element data is not suitable for the OpenVG API, the preprocessing unit 381 may process the corresponding element data using the basic API 350.

The converter 385 converts the vector graphics element into a vector graphics object. The vector graphics object may be a final object obtained by combining various elements of the OpenVG API to process the vector graphics element by an OpenVG engine.

The rendering unit 386 drives the OpenVG API to render the vector graphics object. The rendering unit 386 may be implemented by hardware.

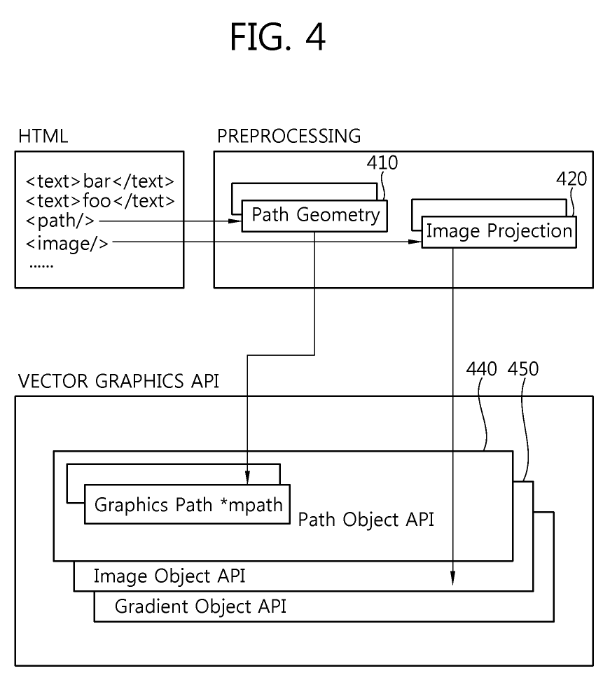

FIG. 4 illustrates content driving using a vector graphics processor. When an HTML document is read in the browser, various tags used for processing graphics in the content are parsed. The parsed element data include <path/>, <image/>, </text>, and the like. The parsed element data are converted into vector graphics elements through preprocessing. Here, it is assumed that there are ‘Path’ (Path Geometry) 410 object and ‘Image’ (Image Projection) 420 object as OpenVG-based objects. The respective vector graphics elements are combined with the OpenVG API into a vector graphics object. The vector graphic element ‘Path’ 410 is converted into a path object API 440, a vector graphics object, and the vector graphics element ‘Image’ 420 is converted into an image object API 450, a vector graphics object.

Because data of various Web pages inputted using the browser are effectively processed and managed, complexity of the operation of adding fabricated content to mobile through separate vector operations can be reduced. Also, various effects can be obtained based on interactions between the content and other pure objects, such as HTML, Java script, etc.

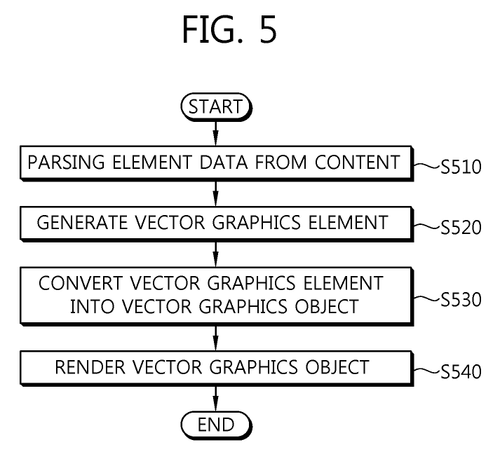

FIG. 5 is a flow chart illustrating a vector graphics processing method according to an embodiment of the present disclosure. This method may be processed by the vector graphics processor, for example. The vector graphics processor may support the OpenVG by the vector graphics API. The vector graphics processor parses element data from the content included in an application (S510). The element data may be various tags used for processing graphics of the content.

The vector graphics processor generates a vector graphics element for processing vector graphics upon receiving the element data, which has been parsed from the content (S520). The element data is made up of a HTML Tag and the like, so an object is generated to process a vector element suitable for the OpenVG. The vector graphics processor checks whether or not the element data is suitable for the OpenVG API, and when the element data is suitable for the OpenVG API, the vector graphics processor may generate the OpenVG API-based vector graphics element. When the element data is not suitable for the OpenVG API, the element data may be processed by the basic API.

The vector graphics processor converts the vector graphics element into a vector graphics object (S530). The vector graphics object may be a final object obtained by combining various elements of the OpenVG API to process the vector graphics element by the OpenVG engine.

The vector graphics processor drives the vector graphics API to render the vector graphics object (S530).

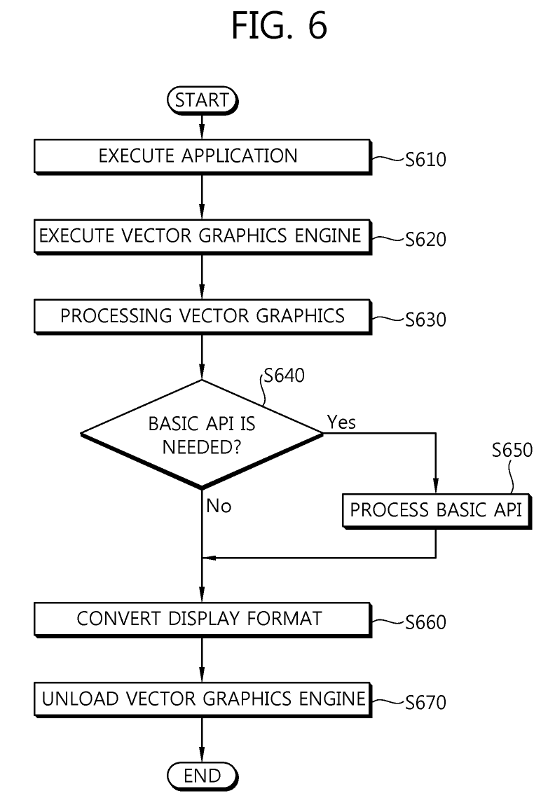

FIG. 6 is a flow chart illustrating an application driving method according to an embodiment of the present disclosure. This method may be performed by a mobile device. The mobile device drives an application in a browser (S610). The application may include content that needs vector graphics processing.

Also, the mobile device drives a vector graphics engine (S620). The vector graphics engine may be configured based on the OpenVG engine. In order to initialize driving of the vector graphics engine, the mobile device checks or inspects various conditions such as an installed memory, whether or not a TASK is to be performed, and the like by using the basic API within the mobile device. When the mobile device detects that there is no problem for driving the installed OpenVG engine, the mobile device may secure an internal memory space for performing vector calculation by using the basic API. In addition, when the mobile device detects that there is no problem for driving the installed OpenVG engine, the mobile device checks or inspects whether to perform real time TASK with the browser in the mobile device and a user interface (UI) TASK status for event processing.

In addition, the mobile device processes the vector graphics (S630). In order to process the vector graphics, the mobile device parses the element data from the content included in an application, and generates a vector graphics element for processing the vector graphics from the parsed element data. The mobile device converts the vector graphics element into a vector graphics object. The mobile device drives the vector graphics API to render the vector graphics object.

The mobile device checks whether or not the basic API is required to display the content (S640). When the mobile device detects that an element for performing the basic API is generated, the control authority is handed over to the browser using the TASK interworking in real time with the browser in the mobile device to process the basic API (S650). The browser calls the installed basic API to generate an object with respect to a required element, and stores the generated object in a frame memory. The object data stored in the frame memory is integrated with the vector graphics-processed data.

The mobile device converts a display format of the vector graphics engine such that the vector graphics engine corresponds to a display format of the display unit of the mobile device (S660). For example, the display format of the display unit may include RGB565, 1444, 8888, RGBA32, BGRA32, and the like.

When the application is terminated and processing of every vector graphics to be performed is completed, the mobile device unloads the vector graphics engine. The TASK for interworking with the browser in real time is called to transmit an end signal of the vector graphics engine to the browser, and the internal memory used by the vector graphics engine is released. Various resources which have been used by the vector graphics engine are returned, and the event and control authorities are all returned to the browser.

The preferred embodiments of the present disclosure have been described with reference to the accompanying drawings, and it will be apparent to those skilled in the art that various modifications and variations can be made in the present disclosure without departing from the scope of the disclosure. Thus, it is intended that any future modifications of the embodiments of the present disclosure will come within the scope of the appended claims and their equivalents.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specifics, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application.

What is claimed is:

1. A vector graphics processor comprising:
a preprocessing unit configured to generate a vector graphics element for vector graphics processing in response to receiving element data parsed from content included in an application;
a converter to communicate with the preprocessing unit and configured to convert the generated vector graphics element into a vector graphics object; and
a rendering unit to communicate with the converter and configured to render the vector graphics object by driving a vector graphics application programming interface (API).

2. The vector graphics processor of claim 1, wherein the preprocessing unit is configured to check whether the received element data is suitable for the vector graphics API, and when the element data is detected to be suitable for the vector graphics API, the preprocessing unit generates the vector graphics element based on the vector graphics API.

3. The vector graphics processor of claim 2, wherein the preprocessing unit comprises a database unit having attribute information defining each generated vector graphic element, and the preprocessing unit is configured to check whether the received element data is suitable for the vector graphics API by comparing the received element data with the attribute information.

4. The vector graphics processor of claim 1, further comprising:
a script parser configured to parse the received element data from the content.

5. The vector graphics processor of claim 4, wherein the script parser supports at least one of hypertext markup language (HTML), extensible markup language (XML), and cascading style sheet (CSS).

6. The vector graphics processor of claim 1, wherein the vector graphics API is based on OpenVG.

7. A mobile device comprising:
a processor configured to drive an application;
a vector graphics processor to communicate with the processor and configured to process content included in the application; and
a display unit to communicate with the processor and the vector graphics processor, wherein the display unit is configured to display the application;
wherein the vector graphics processor comprises:
a preprocessing unit configured to generate a vector graphics element for vector graphics processing in response to receiving element data parsed from the content;
a converter to communicate with the preprocessing unit and configured to convert the generated vector graphics element into a vector graphics object; and
a rendering unit to communicate with the converter and configured to render the vector graphics object by driving a vector graphics application programming interface (API).

8. The mobile device of claim 7, wherein the processor comprises a script parser configured to parse the received element data from the content.

9. The mobile device of claim 8, wherein the script parser supports at least one of hypertext markup language (HTML), extensible markup language (XML), and cascading style sheet (CSS).

10. The mobile device of claim 7, wherein the preprocessing unit is configured to check whether the received element data is suitable for the vector graphics API, and when the element data is suitable for the vector graphics API, the preprocessing unit generates the vector graphics element based on the vector graphics API.

11. The mobile device of claim 10, wherein the preprocessing unit comprises a database unit having attribute information defining each generated vector graphic element, and the preprocessing unit is configured to check whether the received element data is suitable for the vector graphics API by comparing the received element data with the attribute information.

12. The mobile device of claim 7, wherein the application is driven in a browser that displays information on the Web.

13. The mobile device of claim 7, wherein the vector graphics API is based on OpenVG.

14. A method of driving an application including content by a mobile device, the method comprising:
driving a vector graphics engine;
parsing element data from the content;
generating a vector graphics element for vector graphics processing from the parsed element data;
converting the generated vector graphics element into a vector graphics object;
rendering the vector graphics object by driving a vector graphics application programming interface (API); and
displaying the rendered vector graphics object in the application.

15. The method of claim 14, comprising checking whether the parsed element data is suitable for the vector graphics API, and when detecting that the parsed element data is suitable for the vector graphics API, generating the vector graphics element based on the vector graphics API.

16. The method of claim 15, wherein checking whether the received element data is suitable for the vector graphics API comprises comparing the element data with attribute information.

17. The method of claim 14, comprising driving the application in a browser that displays information on the Web.
